(19) United States
(12) Patent Application Publication
(10) Pub. No.: US 2006/0030658 A1
(43) Pub. Date: Feb. 9, 2006

(54) Tire with rubber sidewall containing aromatic and naphthenic/paraffinic processing oils and brominated copolymer of isobutylene and para-methylstyrene

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/911,917

(22) Filed: Aug. 5, 2004

(51) Int. Cl. B60C 1/00; C08K 3/34; C08K 3/04

(52) U.S. Cl. 524/492; 524/495

(57) ABSTRACT

A tire having a visible sidewall of a rubber composition containing a combination of aromatic and naphthenic/paraffinic rubber processing oils together with a brominated copolymer of isobutylene and para-methylstyrene, which also contains cis 1,4-polybutadiene rubber, and a minor amount of at least one additional conjugated diene-based rubber, preferably cis 1,4-polyisoprene rubber. In a further aspect of the invention, the rubber composition may be reinforced with a reinforcing filler as carbon black or as a combination of carbon black and silica together with a coupling agent.

### FIELD OF THE INVENTION

A tire having a visible sidewall of a rubber composition containing a combination of aromatic and naphthenic/paraffinic rubber processing oils together with a brominated copolymer of isobutylene and para-methylstyrene which also contains cis 1,4-polybutadiene rubber, and a minor amount of at least one additional conjugated diene-based rubber, preferably synthetic cis 1,4-polyisoprene rubber. In a further aspect of the invention, the rubber composition may be reinforced with a reinforcing filler as carbon black or as a combination of carbon black and silica together with a coupling agent.

### BACKGROUND OF THE INVENTION

Pneumatic tires have sidewalls which are conventionally desired to have good resistance to flex fatigue, scuff resistance and resistance to tear. A suitable visual appearance of the tire sidewall surface may also be a desirable property.

Scuff resistance for a tire sidewall rubber composition may be enhanced by inclusion of cis 1,4-polybutadiene rubber in the rubber composition itself which is well known to those having skill in such art.

Resistance to flex fatigue for a tire rubber sidewall may sometimes be enhanced by inclusion of an aromatic, naphthenic or paraffinic rubber processing oil in the sidewall rubber composition which is also well known by those having skill in such art.

Inclusion of a brominated copolymer of isobutylene and para-methylstyrene in rubber compositions for various tire components, including tire sidewalls, is further well known to those having skill in such art.

However, for this invention, it is envisioned that a tire with a sidewall having a visible surface composed of a rubber composition which contains a combination of aromatic and naphthenic/paraffinic rubber processing oils together with cis 1,4-polybutadiene rubber, brominated copolymer of isobutylene and para-methylstyrene which may contain a minor amount of cis 1,4-polyisoprene rubber. This tire sidewall composition is considered herein to be novel and a departure from past practice.

The aromatic rubber processing oil is conventionally defined, according to ASTM D2140, as having at least 35 weight percent aromatic carbon. A representative example of an aromatic rubber processing oil is Sundex 8125™ from the Sun Oil Company.

The naphthenic/paraffinic rubber processing oil is conventionally defined, according to ASTM D2140 as containing at least 30 weight percent naphthenic carbon, at least 40 weight percent paraffinic carbon and less than 15 weight percent aromatic carbon. A representative example of a naphthenic/paraffinic rubber processing oil is Flexon 641™ from the Exxon Company

A significant aspect of the invention is the use of a combination of the aromatic rubber processing oil and naphthenic/paraffinic rubber processing oil in a weight ratio thereof in a range of from about 3/1 to about 1/3 instead of using the aromatic rubber processing oil individually or the naphthenic/paraffinic rubber processing oil individually, together with the brominated copolymer of isobutylene and para-methylstyrene, and particularly including the cis 1,4-polybutadiene rubber. This combination of ingredients is considered herein as being a novel composition to produce optimum sidewall properties as a departure from past practice.

Historically, various additives have been used to replace rubber processing oils in various rubber compositions for tire components, including tire sidewalls with liquid polymers which can be co-cured with the rubber composition and thereby become a part of the elastomer network of the rubber composition itself. For example, see U.S. Pat. No. 6,255,397 which relates to the replacement of conventional rubber processing oils with a hydroxyl terminated liquid polyalkylene-based polymer in a rubber blend composition containing a brominated copolymer of isobutylene and para-methylstyrene.

However, it remains desirable to continue to improve various properties for a tire rubber sidewall and the focus here is upon a discovery that the use of a combination of aromatic and naphthenic/paraffinic rubber processing oils, where each of the rubber processing oils amounts to a significant content of the rubber processing oil mixture, has been observed to provide the best combination of cured and uncured properties which include building tack, tear strength, adhesion to ply and wire coat rubber compounds, improved flex or cut growth resistance and excellent static and dynamic ozone resistance.

In the description of this invention, the term “phr” as used herein, and according to conventional practice, refers to “parts of a respective material per 100 parts by weight of rubber”. The terms “rubber” and “elastomer” can be used interchangeably, unless otherwise indicated. The terms “rubber composition”, “compounded rubber” and “rubber compound” can be used interchangeably to refer to “rubber which has been blended or mixed with various ingredients and materials” and the terms “cure” and “vulcanize” may also be used interchangeably herein, unless otherwise indicated and such terms are well known to those having skill in the rubber mixing or rubber compounding art.

### SUMMARY AND PRACTICE OF THE INVENTION

In accordance with this invention a tire is provided having a visible sidewall of a rubber composition comprised of, based upon parts by weight per 100 parts by weight rubber (phr):

(A) 100 phr of elastomers comprised of
(1) about 30 to about 70, alternately about 35 to about 65, phr of cis 1,4-polybutadiene rubber,
(2) zero to about 30, alternately and preferably about 5 to about 25, phr of cis 1,4-polyisoprene rubber, and
(3) about 30 to about 70, alternately about 40 to about 60, phr of brominated copolymer of isobutylene and p-methylstyrene,
(4) optionally about 2 to about 15 phr of an additional conjugated diene-based elastomer;

(B) about 4 to about 40, alternately about 6 to about 30, phr of rubber processing oils comprised of from about 1 to about 30 phr of aromatic rubber processing oil (ASTM D2140) and from about 1 to about 30 phr of naphthenic/paraffinic rubber processing oil (ASTM D2140),

wherein the weight ratio of said aromatic rubber processing oil to said naphthenic/paraffinic rubber processing oil is in a range of from about 3/1 to about 1/3, and

(C) about 15 to about 70 phr of reinforcing filler as:
(1) carbon black, or
(2) combination of 13 to 55 phr of carbon black containing from 2 to 25 phr synthetic precipitated silica, optionally with a coupling agent having a moiety reactive with hydroxyl groups (e.g. silanol groups) contained on the precipitated silica and another moiety interactive with said conjugated diene-based elastomer(s).

It is a significant aspect of this invention that the rubber composition is suitable for a tire sidewall where high flex endurance properties over a considerable period of time and good resistance to atmospheric ozone degradation without use of amine-based antidegradants in the rubber composition is desired.

In further accordance with this invention, a tire is provided having said visible sidewall rubber composition as a sulfur cured rubber composition. For such tire, the unvulcanized tire assembly, including its sidewall rubber composition, is vulcanized in a suitable mold at an elevated temperature to shape and sulfur-vulcanize the associated rubber compositions of the tire.

The use of a combination of the aforesaid rubber processing oils together with the brominated copolymer of isobutylene and para-methylstyrene and cis 1,4-polybutadiene rubber in a visible tire sidewall rubber composition, as hereinbefore discussed is considered to be a novel development.

A significant aspect of the invention is, therefore, a resultant sidewall rubber composition comprised of such materials which have been observed to exhibit acceptable resistance to flex fatigue property over a considerable period of time as well as acceptable resistance to dynamic atmospheric ozone degradation of the rubber composition without requiring an amine-based antioxidant in the rubber composition itself. Enhanced resistance to tear strength and adhesion to other tire components (e.g. wire coat and ply coat rubber compounds) are also observed to have been achieved with this novel composition.

In one aspect this is considered herein to be advantageous for a tire sidewall rubber composition in order to improve, or substantially maintain, visible tire sidewall surface appearance after aging while maintaining good durability properties (e.g. flex and tear resistance) of the sidewall rubber composition itself.

In practice, as hereinbefore pointed out, the sidewall rubber composition may also contain up to about 15, alternately about 2 to about 15, phr of at least one additional conjugated diene-based elastomer. Representative of such additional conjugated diene-based elastomers are, for example, polymers of at least one of isoprene and 1,3-butadiene and/or copolymer of styrene and at least one of isoprene and 1,3-butadiene. Representative examples of such elastomers are, for example, styrene/butadiene copolymer rubbers, isoprene/butadiene copolymer rubbers and styrene/isoprene/butadiene terpolymer rubber. Said additional elastomers may also be a tin coupled elastomer.

In practice, the cis 1,4-polyisoprene rubber for the rubber composition may be natural or synthetic rubber, usually preferably natural rubber.

In practice, it is preferred that the reinforcing filler is carbon black. If desired, silica, particularly precipitated silica which is also intended to include a synthetic precipitated aluminosilicate, (e.g. a synthetic silica precipitated with, or otherwise treated, a very small amount or aluminum) can be present at a level of up to 15 phr (e.g. from about 2 to about 15 phr).

As would be understood by one having skill in such art, a coupling agent would normally be used for said precipitated silica, although the precipitated silica might be used without, and therefore exclusive of, a coupling agent to aid in coupling the precipitated silica to said diene-based elastomers or other ingredients in the rubber composition.

Such coupling agent may be, for example, a bis-(3-triethoxysilylpropyl)polysulfide having an average of from about 2 to about 4, and particularly an average of from 2 to about 2.6 or an average of from about 3.4 to about 3.8, connecting sulfur atoms in its polysulfidic bridge. In one aspect of the practice of this invention, such coupling agent is preferably is a bis-(3-triethoxysilylpropyl)polysulfide having an average of from 2 to 2.6 connecting sulfur atoms in its polysulfidic bridge.

The brominated copolymer of isobutylene and para-methylstyrene for this application is a copolymer comprised of repeat units derived from isobutylene and para-methylstyrene. Preferably, the copolymer is composed of from about 85 to about 99 weight percent units derived from isobutylene.

In practice, it is considered herein that copolymer is post-brominated and has a resultant bromine content of up to about 5 weight percent and, alternately, from about 0.2 to about 1.5 or even up to 2.5 weight percent in the copolymer.

A representative copolymer is a brominated copolymer of isobutylene and para-methylstyrene as, for example, EXXPRO from the Exxon Chemical Company reportedly having a Mooney Viscosity ML(1-8) at 125° C. of 50±10, an isobutylene content of about 94 to 95 weight percent, and a para-methylstyrene content of about 5 percent, with a total bromine content of about 0.8 weight percent. European patent publication No. EP 0.344.021 contains a description of how to make such copolymer. Also, reference may be made to European Patent Publication No. EP 0801105.

The rubber compositions of this invention can be prepared by simply mixing the respective ingredients with the rubber elastomer. This can be done utilizing a wide variety of mixing techniques. In most cases, the mixing will be carried out utilizing an internal rubber mixer or an open roll (e.g. dual opposing rolls) mill mixer. An internal rubber mixer is preferred and it will generally be preferred to mix the aromatic and the naphthenic/paraffinic rubber processing oils into the elastomer composition during the non-productive compounding stage.

It should be noted that the non-productive compounds do not contain curatives, such as sulfur, or accelerators. On the other hand, productive compounds contain a curative which will cure (vulcanize) the rubber after it is heated to a curing temperature.

The vulcanization is conducted in the presence of a sulfur-vulcanizing agent. Examples of suitable sulfur-vulcanizing agents include elemental sulfur (free sulfur) or sulfur donating vulcanizing agents, for example, an amine disulfide, polymeric polysulfide, alkyl phenol polysulfides or sulfur olefin adducts. As known to those skilled in the art, sulfur-vulcanizing agents are used in an amount ranging from about 0.5 to about 4 phr, or even, in some circumstances, up to about 8 phr, with a range of from about 1.5 to about 2.5, sometimes from 2 to 2.5, being preferred. It is to be appreciated, however, that the cure system, including desired cure package ingredients as well as the following discussion concerning cure accelerators, may vary depending upon the rubber compound ingredients, including the chosen polymers and elastomers.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from about 0.5 to about 4, preferably about 0.8 to about 2.8, phr. In another embodiment, combinations of a primary and a secondary accelerator might be used with the secondary accelerator being used in smaller amounts (of about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Some representative examples of primary accelerators which can be utilized include thiazole accelerators, such as benzothiazyldisulfide and 2-mercaptobenzothiazole; sulfenamide accelerators, such as N-oxydiethylene benzothiazole-2-sulfenamide, N-t-butyl-2-benzothiazolesulfenamide and N-cyclohexyl-2-benzothiazolesulfenamide; dithiocarbamate accelerators, such as bismuth dimethyldithiocarbamate, cadmium diethyldithiocarbamate, copper dimethyldithiocarbamate, lead dimethyldithiocarbamate, selenium diethyldithiocarbamate, tellurium diethyldithiocarbamate and zinc dimethyldithiocarbamate; thiuram accelerators such as dipentamethylene thiuram hexasulfide, tetramethylthiuram monosulfide and tetraethylthiuram monosulfide; and thiourea accelerators, such as trimethyl thiourea and dimethylethyl thiourea. If a second accelerator is used, the secondary accelerator is preferably a guanidine, dithiocarbamate or thiuram compound.

The following examples are used to illustrate the invention. The parts and percentages are by weight unless otherwise indicated.

### EXAMPLE I

A series of samples were prepared to evaluate the use of a combination of aromatic rubber processing oil and naphthenic/paraffinic rubber processing oil in a rubber composition which also contains a brominated copolymer is isobutylene and para-methylstyrene.

These two rubber processing oils are intended to replace an individual use of either an aromatic rubber processing oil or a naphthenic/paraffinic rubber processing oil alone.

The samples are referred to herein as Samples A through D.

Sample A is a Control Sample which contained use of an individual naphthenic/paraffinic rubber processing oil.

Sample D is a Control Sample which contained use of an individual aromatic rubber processing oil.

Samples B and C contained various combinations of the naphthenic/paraffinic rubber processing oil and aromatic rubber processing oil.

The Samples A through D are prepared in a three step, or stage, sequential, mixing process in an internal rubber mixer, namely, a first and second non-productive mixing stage in an internal rubber mixer followed by a productive mixing stage in an internal rubber mixer.

The elastomers, indicated compounding ingredients, including the elastomers and processing oils, are added in the first, non-productive, mixing stage. The second non-productive stage is a re-mixing of the composition formed by mixing the ingredients added in the aforesaid first mixing stage.

In particular, the mixing is conducted in the first stage for about four minutes to a temperature of about 160° C., dumped from the internal rubber mixer, open roll milled for about 30 seconds, sheeted out and allowed to cool to a temperature below 30° C. The resulting rubber composition is then re-mixed in a second mixing stage for about two minutes to a temperature of about 150° C., dumped from the internal rubber mixer, open roll milled for about 30 seconds, sheeted out and allowed to cool to a temperature below 30° C.

In a subsequent mixing stage (a productive mixing stage in an internal rubber mixer), the sulfur curative and accelerator(s) are mixed with the rubber composition and the mixture mixed for about two minutes to a temperature of about 110° C., dumped from the rubber mixer, open roll milled for about 30 seconds, sheeted out, and allowed to cool to a temperature below 30° C.

The various ingredients for the Samples are illustrated in the following Table 1.

TABLE 1

| | Parts by |
|---|---|
| | Weight |
| First Non-Productive Mix Stage | |
| Natural rubber¹ | 10 |
| Cis 1,4-Polybutadiene rubber² | 40 |
| Brominated copolymer of isobutylene and p-methylstyrene³ | 50 |
| Carbon black⁴ | 40 |
| Tackifier/fatty acid⁵ | 6 |
| Naphthenic/paraffinic rubber processing oil⁶ | variable |
| Aromatic rubber processing oil⁷ | variable |
| Second Non-Productive Mix Stage | |
| No added ingredients, re-mill of first non-productive | |
| mix stage | |
| Productive Mix Stage | |
| Zinc oxide | 0.75 |
| Stearic acid | 0.5 |
| Sulfur | 0.4 |
| Accelerators⁸ | 1.4 |

¹Natural cis 1,4-polyisoprene rubber (Grade TSR20)
²Cis 1,4-polybutadiene rubber prepared by solution polymerization as BUDENE ® 1207 from The Goodyear Tire & Rubber Company
³Brominated copolymer of isobutylene and para-methylstyrene obtained as MDX 93-4 ™ from the Exxon Chemical Company
⁴N660 carbon black, an ASTM designation
⁵Phenol-formaldehyde based resin and fatty acid, primarily, stearic acid as Struktol 60MS ™ from the Struktol Company.
⁶Naphthenic/paraffinic rubber processing oil as Flexon 641 ™ from the Exxon Company
⁷Aromatic rubber processing oil as Sundex 8125 ™ from the Sun Oil Company
⁸Combination of benzothiazole disulfide (MBTS) and alkyl phenol polysulfide

The Samples were prepared from the formulation represented in Table 1 using the “variable” amounts of the rubber processing oils as more fully illustrated shown in Table 2 together with various physical properties. For the cured sample evaluations, the respective Samples were vulcanized in a suitable mold for about 12 minutes at a temperature of about 170° C.

TABLE 2

| | Samples | | | |
|---|---|---|---|---|
| | Control | | | Control |
| | A | B | C | D |
| Ingredients | | | | |
| Naphthenic/paraffinic processing oil | 17 | 12 | 7 | 0 |
| Aromatic processing oil | 0 | 5 | 10 | 17 |
| Properties | | | | |
| Rheometer, 170° C. (MDR)¹ | | | | |
| Maximum torque (dNm) | 7.4 | 7.2 | 7 | 6.9 |
| Minimum torque (dNm) | 1.1 | 1.2 | 1.3 | 1.3 |
| Delta torque | 6.3 | 6 | 5.7 | 5.6 |
| T₉₀, minutes | 7.3 | 7.1 | 6.9 | 7.1 |
| Stress-Strain (ATS)² | | | | |
| Tensile strength, ultimate (MPa) | 11.8 | 12.6 | 13.3 | 13.8 |
| Elongation, ultimate (%) | 665 | 695 | 737 | 764 |
| Modulus, ring, 300% (MPa) | 4.6 | 4.4 | 4.2 | 4.1 |
| Rebound, 100° C. (%) | 58 | 56 | 55 | 54 |
| Hardness, Shore A, 100° C.³ | 41 | 41 | 41 | 40 |
| Tear strength, N, 95° C.⁴ | 62 | 78 | 96 | 102 |
| Adhesion to wire coat compound (N)⁵ | 62 | 68 | 78 | 101 |
| Adhesion to polyester ply coat compound(N)⁶ | 58 | 72 | 59 | 67 |
| Ozone Aging Tests | | | | |
| Static ozone test, 25%⁷ | 0 | 0 | 0 | 0 |
| Dynamic ozone test, 25%⁸ | 0 | 0 | 0 | Cracking¹¹ |
| Pierced groove flex test⁹ (inches at 240 minutes) | 0.37 | 0.28 | 0.24 | 0.13 |
| Tack, uncured (N)¹⁰ | 6 | 5 | 4 | 3 |

¹Data obtained according to Moving Die Rheometer instrument, model MDR-2000 by Alpha Technologies, used for determining cure characteristics of elastomeric materials, such as for example Torque, T90 etc.
²Data obtained according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³Shore A hardness according to ASTM D-1415
⁴Data obtained according to a peel strength adhesion (tear strength) test to determine interfacial adhesion between two samples of the same rubber composition. In particular, such interfacial adhesion is determined by pulling one rubber composition away from the other at a right angle to the untorn test specimen with the two ends of the rubber compositions being pulled apart at a 180° angle to each other using an Instron instrument.
^{5,6}Adhesion of a Sample compound to a wire coat rubber compound or a ply coat rubber compound conducted in the manner of the Tear Strength Test at 95° C. and expressed in terms of Newtons
⁷Static ozone test of the cured Samples, of a size of about 15.2 cm by 1.3 cm, in an enclosed container in an atmosphere which contains 50 pphm (parts per 100 million gaseous concentration) at about 23° C. and 25 percent strain (25 percent elongation) for about 48 hours. A visual rating of zero indicates no cracking of the sample
⁸The Dynamic ozone test is conducted in a manner similar to the above Static test except that the Samples are dynamically continuously flexed, without relaxation, during the test. A visual inspection of the resulting Samples indicated no cracks and therefore a rating of zero was given.
⁹Pierced groove flex values were determined by continuous dynamic flexing and measuring the extent of crack growth and expressed in terms of inches at 240 minutes of flexing at 23° C.
¹⁰Tack of the uncured Sample to another rubber in its uncured state which is conventionally referred to as “building tack”.
¹¹Cracking of the surface was observed for Control Sample D, which contained only the aromatic rubber processing oil, which exhibited the surface cracking upon being subjected to a dynamic (continuous flexing at a 25 percent strain) accelerated ozone test whereas the Control Sample A which contained only the naphthenic/paraffinic oil, as well as Samples B and C, did not exhibit surface cracking.

From Table 2 it can be seen that use of the aromatic rubber processing oil alone (Control Sample D) provided a rubber sample which exhibited suitable tear strength, adhesion to wire and polyester rubber coat compounds but, however, provided a rubber sample which exhibited an unwanted surface cracking under the dynamic ozone test.

Limiting the rubber processing oil to the naphthenic/paraffinic processing oil (Control Sample A) provided a rubber sample which did not exhibit surface cracking under the dynamic ozone test. However, it had lower tear strength, lower adhesion to wire coat and polyester ply coat rubber compounds and worse flex or cut growth resistance.

Using the combination of aromatic rubber processing oil and the naphthenic/paraffinic rubber processing oil (Sample B and Sample C) resulted in an achievement of the best overall balance of properties while maintaining satisfactory ozone resistance which is considered herein to be an essential property.

While certain representative embodiments and details have been shown for the purpose of illustrating the invention, it will be apparent to those skilled in this art that various changes and modifications may be made therein without departing from the spirit or scope of the invention.

What is claimed is

1. A tire having a visible sidewall of a rubber composition comprised of, based upon parts by weight per 100 parts by weight rubber (phr):
(A) 100 phr of elastomers comprised of
(1) about 30 to about 70 phr of cis 1,4-polybutadiene rubber,
(2) zero to about 30 phr of cis 1,4-polyisoprene rubber, and
(3) about 30 to about 70 phr of brominated copolymer of isobutylene and p-methylstyrene,
(B) about 4 to about 40 phr of rubber processing oils comprised of from about 1 to about 30 phr of aromatic rubber processing oil and from about 1 to about 30 phr of naphthenic/paraffinic rubber processing oil
wherein the weight ratio of said aromatic rubber processing oil to said naphthenic/paraffinic rubber processing oil is in a range of from about 3/1 to about 1/3, and
(C) about 15 to about 70 phr of reinforcing filler as:
(1) carbon black, or
(2) combination of 13 to 55 phr of carbon black containing from 2 to 25 phr synthetic precipitated silica, optionally with a coupling agent having a moiety reactive with hydroxyl groups (e.g. silanol groups) contained on the precipitated silica and another moiety interactive with said conjugated diene-based elastomer(s).

2. The tire of claim 1, wherein said visible sidewall rubber composition is comprised of, based upon parts by weight per 100 parts by weight rubber (phr):
(A) 100 phr of elastomers comprised of
(1) about 35 to about 65 phr of cis 1,4-polybutadiene rubber,
(2) about 5 to about 25 phr of cis 1,4-polyisoprene rubber,
(3) about 40 to about 60 phr of brominated copolymer of isobutylene and p-methylstyrene,
(4) optionally about 2 to about 15 phr of an additional conjugated diene-based elastomer selected from polymers of at least one of isoprene and 1,3-butadiene and copolymers of styrene and at least one of isoprene and 1,3-butadiene;
(B) about 6 to about 30 phr of rubber processing oils comprised of from about 1 to about 30 phr of aromatic rubber processing oil (ASTM D2140) and from about 1 to about 30 phr of naphthenic/paraffinic rubber processing oil (ASTM D2140)
wherein the weight ratio of said aromatic rubber processing oil to said naphthenic/paraffinic rubber processing oil is in a range of from about 3/1 to about 1/3, and
(C) about 15 to about 70 phr of reinforcing filler as:
(1) carbon black, or
(2) combination of 13 to 55 phr of carbon black containing from 2 to 25 phr synthetic precipitated silica, optionally with a coupling agent having a moiety reactive with hydroxyl groups (e.g. silanol groups) contained on the precipitated silica and another moiety interactive with said conjugated diene-based elastomer(s).

3. The tire of claim 2 wherein said visible rubber sidewall rubber composition contains from about 2 to about 15 phr of an additional conjugated diene-based elastomer selected from polymers of at least one of isoprene and 1,3-butadiene and copolymers of styrene and at least one of isoprene and 1,3-butadiene.

4. The tire of claim 2 wherein the reinforcing filler for said visible rubber sidewall rubber composition is carbon black.

5. The tire of claim 3 wherein the reinforcing filler for said visible rubber sidewall rubber composition is carbon black.

6. The tire of claim 1 wherein, for said visible rubber sidewall rubber composition, said aromatic rubber processing oil contains at least 35 weight percent aromatic carbon (ASTM D2140) and said naphthenic/paraffinic rubber processing oil contains least 30 weight percent naphthenic carbon, at least 40 weight percent paraffinic carbon and less than 15 weight percent aromatic carbon.

7. The tire of claim 2 wherein, for said visible rubber sidewall rubber composition, said aromatic rubber processing oil contains at least 35 weight percent aromatic carbon (ASTM D2140) and said naphthenic/paraffinic rubber processing oil contains least 30 weight percent naphthenic carbon, at least 40 weight percent paraffinic carbon and less than 15 weight percent aromatic carbon.

8. The tire of claim 3 wherein, for said visible rubber sidewall rubber composition, said aromatic rubber processing oil contains at least 35 weight percent aromatic carbon (ASTM D2140) and said naphthenic/paraffinic rubber processing oil contains least 30 weight percent naphthenic carbon, at least 40 weight percent paraffinic carbon and less than 15 weight percent aromatic carbon.

9. The tire of claim 4 wherein, for said visible rubber sidewall rubber composition, said aromatic rubber processing oil contains at least 35 weight percent aromatic carbon (ASTM D2140) and said naphthenic/paraffinic rubber processing oil contains least 30 weight percent naphthenic carbon, at least 40 percent weight paraffinic carbon and less than 15 weight percent aromatic carbon.

10. The tire of claim 2 wherein said cis 1,4-polyisoprene is natural rubber.

11. The tire of claim 2 wherein said additional conjugated diene-based elastomer is selected from at least one of styrene/butadiene copolymer rubber, isoprene/butadiene copolymer rubber and styrene/isoprene/butadiene terpolymer.

12. The tire of claim 11 wherein said additional conjugated diene-based elastomer is a tin coupled elastomer.

13. The tire of claim 1 wherein said brominated copolymer is comprised of about 85 to about 99 weight percent units derived from isobutylene.

14. The tire of claim 2 wherein said brominated copolymer is comprised of about 85 to about 99 weight percent units derived from isobutylene.

15. The tire of claim 1 wherein said reinforcement is a combination of carbon black and precipitated silica and is exclusive of silica coupling agent.

16. The tire of claim 2 wherein said reinforcement is a combination of carbon black and precipitated silica and is exclusive of silica coupling agent.

17. The tire of claim 1 wherein said reinforcement is a combination of carbon black and precipitated silica and said rubber composition contains a silica coupling agent having a moiety reactive with hydroxyl groups on the surface of said precipitated silica and another moiety interactive with said conjugated diene-based elastomer(s).

18. The tire of claim 2 wherein said reinforcement is a combination of carbon black and precipitated silica and said rubber composition contains a silica coupling agent having a moiety reactive with hydroxyl groups on the surface of said precipitated silica and another moiety interactive with said conjugated diene-based elastomer(s).

19. The tire of claim 17 wherein said coupling agent is a bis(3-triethoxysilylpropyl)polysulfide having an average of from 2 to 2.6 or an average of from 3.5 to 4 connecting sulfur atoms in its polysulfidic bridge.
